(19) United States
(12) Patent Application Publication
(10) Pub. No.: US 2026/0019491 A1
(43) Pub. Date: Jan. 15, 2026

(54) VEHICLE-MOUNTED AND HOUSEHOLD MAGNETIC, FOLDABLE AND ROTATABLE MOBILE PHONE HOLDER CAPABLE OF BEING ADSORBED IN TWO WAYS

(71) Applicant: Dongguan Jinchi Electronic Technology Co., Ltd., Dongguan (CN)

(72) Inventor: Pengcheng DU, Dongguan (CN)

(21) Appl. No.: 19/187,669

(22) Filed: Apr. 23, 2025

(30) Foreign Application Priority Data
Jul. 10, 2024 (CN) 202421625096.6

(51) Int. Cl. H04M 1/04; F16M 11/04; F16M 11/12; F16M 13/02

(52) U.S. Cl. CPC H04M 1/04; F16M 11/041; F16M 11/125; F16M 13/022

(57) ABSTRACT

Disclosed in the present disclosure is a vehicle-mounted and household magnetic, foldable and rotatable mobile phone holder capable of being adsorbed in two ways, which relates to the technical of mobile phone holders. The mobile phone holder includes a lower component, where a rotary supporting frame is mounted on the lower component, and an upper component is mounted at the other end of the rotary supporting frame. Suction cups are mounted on the lower component, and a magnet is mounted on the upper component. A bottom disc is arranged in a bottom cavity of the lower component, and the suction cups are fixedly mounted on the bottom disc. One end of the upper component is provided with an annular groove, and the magnet is annular and embedded in the annular groove. The rotary supporting frame includes a lower connecting member.

### CROSS-REFERENCE TO RELATED APPLICATIONS

The present application claims priority to Chinese Patent Application No. 202421625096.6, filed on July 10, 2024, the entire disclosure of which is incorporated herein by reference.

### TECHNICAL FIELD

The present disclosure relates to the technical field of mobile phone holders, and in particular to a vehicle-mounted and household magnetic, foldable and rotatable mobile phone holder capable of being adsorbed in two ways.

### BACKGROUND

At present, magsafe magnetic holders in a use environment of vehicle-mounted holders capable of being stuck available on the market are inconvenient for angle adjustment and incompatible with POPsockets (airbag ring holder) and Ring (ordinary ring holder). Generally, holders capable of being stuck are only stuck on one type of products, which is inapplicable to products that require varying use scenarios.

### SUMMARY

In view of the problems occurring to an existing vehicle-mounted and household magnetic, foldable and rotatable mobile phone holder capable of being adsorbed in two ways, the present disclosure is provided.

Therefore, an objective of the present disclosure is to provide a vehicle-mounted and household magnetic, foldable and rotatable mobile phone holder capable of being adsorbed in two ways, so as to solve the above problems.

In order to solve the above technical problems, in a first aspect of the present disclosure, the present disclosure provides the technical solutions as follows:

A vehicle-mounted and household magnetic, foldable and rotatable mobile phone holder capable of being adsorbed in two ways, including a lower component, where a rotary supporting frame is mounted on the lower component, and an upper component is mounted at the other end of the rotary supporting frame; and suction cups are mounted on the lower component, and a magnet is mounted on the upper component.

As a preferred solution of the vehicle-mounted and household magnetic, foldable and rotatable mobile phone holder capable of being adsorbed in two ways provided by the present disclosure, a bottom disc is arranged in a bottom cavity of the lower component, and the suction cups are fixedly mounted on the bottom disc.

As a preferred solution of the vehicle-mounted and household magnetic, foldable and rotatable mobile phone holder capable of being adsorbed in two ways provided by the present disclosure, one end of the upper component is provided with an annular groove, and the magnet is annular and embedded in the annular groove.

As a preferred solution of the vehicle-mounted and household magnetic, foldable and rotatable mobile phone holder capable of being adsorbed in two ways provided by the present disclosure, the rotary supporting frame includes a lower connecting member, one end of the lower connecting member is hinged to a swing rod through a second rotary shaft, and one end of the swing rod is hinged to an upper connecting member through a third rotary shaft.

As a preferred solution of the vehicle-mounted and household magnetic, foldable and rotatable mobile phone holder capable of being adsorbed in two ways provided by the present disclosure, the lower component and the bottom disc are jointly arranged on a first rotary shaft in a sleeving manner, and the lower connecting member is connected to the first rotary shaft through a first screw.

As a preferred solution of the vehicle-mounted and household magnetic, foldable and rotatable mobile phone holder capable of being adsorbed in two ways provided by the present disclosure, the upper component and the upper connecting member are connected through a second screw.

As a preferred solution of the vehicle-mounted and household magnetic, foldable and rotatable mobile phone holder capable of being adsorbed in two ways provided by the present disclosure, a hardware decorative sheet is stuck to a nut of the first screw, a first decorative sheet and a second decorative sheet are stuck to two ends of the second rotary shaft respectively, a third decorative sheet and a fourth decorative sheet are stuck to two ends of the third rotary shaft respectively, and a surface sticker is stuck to the magnet.

As a preferred solution of the vehicle-mounted and household magnetic, foldable and rotatable mobile phone holder capable of being adsorbed in two ways provided by the present disclosure, a groove is provided at the first rotary shaft, and a magnetic block is stuck to an interior of the groove.

As a preferred solution of the vehicle-mounted and household magnetic, foldable and rotatable mobile phone holder capable of being adsorbed in two ways provided by the present disclosure, a groove is provided at the first rotary shaft, and an arc-shaped elastic sheet is welded in the groove.

Compared with the prior art:

1. According to the vehicle-mounted and household magnetic, foldable and rotatable mobile phone holder capable of being adsorbed in two ways, a bottom surface housing can realize a 360-degree rotation and hovering function, the swing rod in a middle can realize an up-and-down folding function, and an upper portion can be compatible with POPsockets (airbag ring holder) and Ring (ordinary ring holder).

2. The mobile phone holder is arranged to have two use ways, which truly realizes quick switches of the mobile phone holder among different use scenarios. The mobile phone holder has the two use ways. First use way: the mobile phone holder is adsorbed on a smooth surface such as glass and a table board through the silica suction cups. The magsafe mobile phone adsorption use way may be selected at the scenarios including a household or a vehicle-mounted scenario. Second use way: the upper component provided with the magnet is adsorbed on a metal object such as an iron object and a steel object. The use way of adsorbing a bare mobile phone through the silica gel suction cups may be selected in the use scenarios having metal objects such as a gymnasium. The two use ways can completely cover a plurality of use scenarios, such as the household and vehicle-mounted scenarios, and an exercise and fitness scenario. And therefore, quick switches of one mobile phone holder among different use scenarios is truly realized.

### BRIEF DESCRIPTION OF THE DRAWINGS

FIG. 1 is a schematic diagram of a structure provided by Example 1 of the present disclosure.

FIG. 2 is a bottom view of FIG. 1 provided by Example 1 of the present disclosure.

FIG. 3 is an exploded diagram of FIG. 1 provided by Example 1 of the present disclosure.

FIG. 4 is a schematic diagram of FIG. 1 after dismounting of a surface sticker provided by Example 1 of the present disclosure.

FIG. 5 is a schematic diagram of FIG. 4 after dismounting of an upper component provided by Example 1 of the present disclosure.

FIG. 6 is a sectional view of FIG. 5 provided by Example 1 of the present disclosure.

FIG. 7 is a sectional view of FIG. 5 provided by Example 2 of the present disclosure.

FIG. 8 is a sectional view of FIG. 5 provided by Example 3 of the present disclosure.

FIG. 9 is a schematic diagram of a first rotary shaft provided by Example 3 of the present disclosure.

In the figures: 1. suction cup; 2. first rotary shaft; 3. lower component; 4. first decorative sheet; 5. lower connecting member; 6. second rotary shaft; 7. second decorative sheet; 8. first screw; 9. hardware decorative sheet; 10. swing rod; 11. third decorative sheet; 12. upper connecting member; 13. third rotary shaft; 14. fourth decorative sheet; 15. upper component; 16. magnet; 17. surface sticker; 18. second screw; 19. bottom disc; 20. magnetic block; and 21. arc-shaped elastic sheet.

### DETAILED DESCRIPTIONS OF THE EMBODIMENTS

To make the objectives, technical solutions, and advantages of the present disclosure clearer, the following further describes the embodiments of the present disclosure in detail with reference to the accompanying drawings.

Example 1:

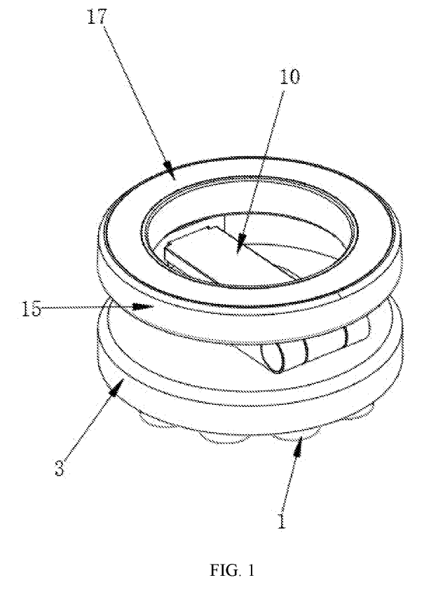

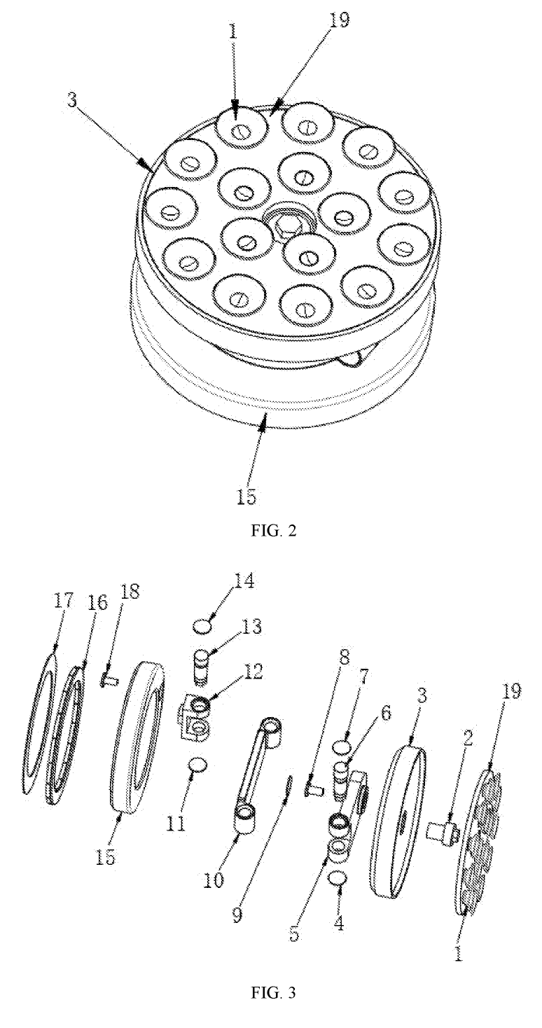

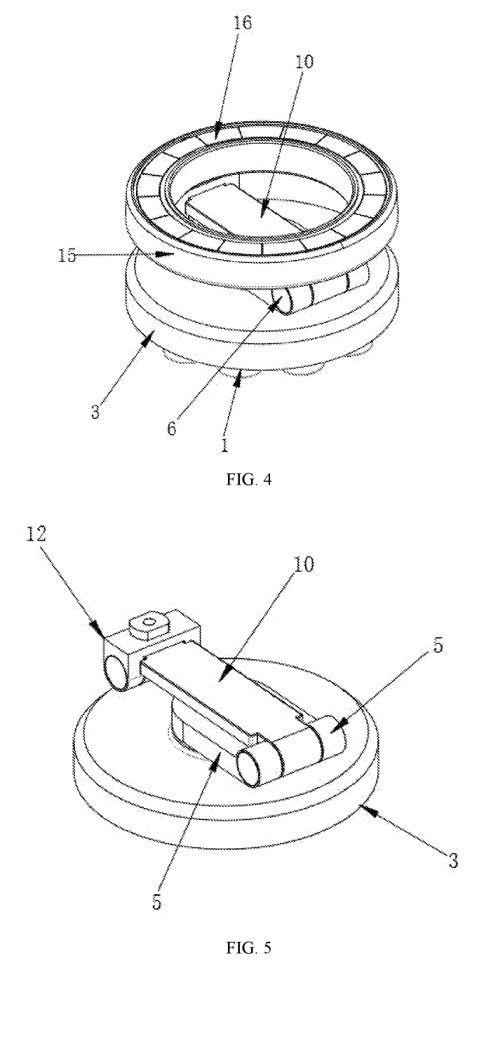

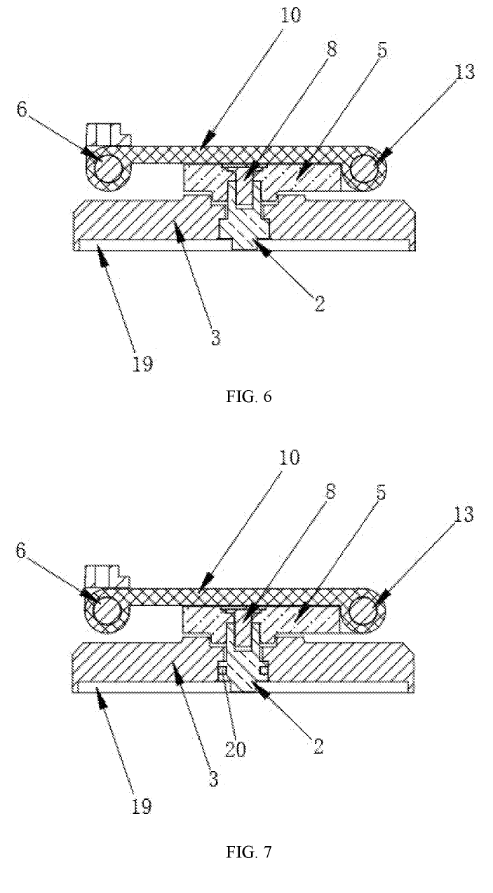

The present disclosure provides a vehicle-mounted and household magnetic, foldable and rotatable mobile phone holder capable of being adsorbed in two ways, referring to FIGS. 1-6, including a lower component 3, where a rotary supporting frame is mounted on the lower component 3, and an upper component 15 is mounted at the other end of the rotary supporting frame; and suction cups 1 are mounted on the lower component 3, a magnet 16 is mounted on the upper component 15, and a surface sticker 17 is stuck to the magnet 16.

A bottom disc 19 is arranged in a bottom cavity of the lower component 3, and the suction cups 1 are fixedly mounted on the bottom disc 19.

One end of the upper component 15 is provided with an annular groove, the magnet 16 is annular and embedded in the annular groove, and the magnet 16 is stuck to an inner wall of the annular groove through glue, thereby ensuring connection firmness of the magnet 16.

The rotary supporting frame includes a lower connecting member 5, and one end of the lower connecting member 5 is hinged to a swing rod 10 through a second rotary shaft 6. A first decorative sheet 4 and a second decorative sheet 7 are stuck to two ends of the second rotary shaft 6 respectively, and a rubber ring is arranged on the second rotary shaft 6 in a sleeving manner, such that the swing rod 10 is prevented from rotating unexpectedly. One end of the swing rod 10 is hinged to an upper connecting member 12 through a third rotary shaft 13, and the upper component 15 and the upper connecting member 12 are connected through a second screw 18. A third decorative sheet 11 and a fourth decorative sheet 14 are stuck to two ends of the third rotary shaft 13 respectively, a rubber ring is arranged on the third rotary shaft 13 in a sleeving manner, and the rubber rings elastically abut against an inner wall of the upper connecting member 12, such that the upper component 15 is prevented from rotating unexpectedly.

The lower component 3 and the bottom disc 19 are jointly arranged on a first rotating 2 in a sleeving manner, the lower connecting member 5 is connected to the first rotary shaft 2 through a first screw 8, and a hardware decorative sheet 9 is stuck to a nut of the first screw 8.

In specific use:

First use way: the mobile phone holder is adsorbed on a smooth surface such as glass and a table board through the suction cups 1. In this case, a mobile phone or a metal mobile phone housing is adsorbed through the magnet 16 on the upper component 15.

Second use way: the upper component 15 is adsorbed on a metal object such as an iron object and a steel object through the magnet 16, and the silica gel suction cups are adsorbed to a bare mobile phone.

Example 2:

Referring to FIG. 7, difference from Example 1 is as follows: a groove is provided at the first rotary shaft 2, and a magnetic block 20 is stuck to an interior of the groove. An inner wall of the lower component 3 is attracted by the magnetic block 20, such that the first rotary shaft 2 is prevented from rotating unexpectedly.

In specific use:

First use way: the mobile phone holder is adsorbed on a smooth surface such as glass and a table board through the suction cups 1. In this case, a mobile phone or a metal mobile phone housing is adsorbed through the magnet 16 on the upper component 15.

Second use way: the upper component 15 is adsorbed on a metal object such as an iron object and a steel object through the magnet 16, and the silica gel suction cups are adsorbed to a bare mobile phone.

Example 3:

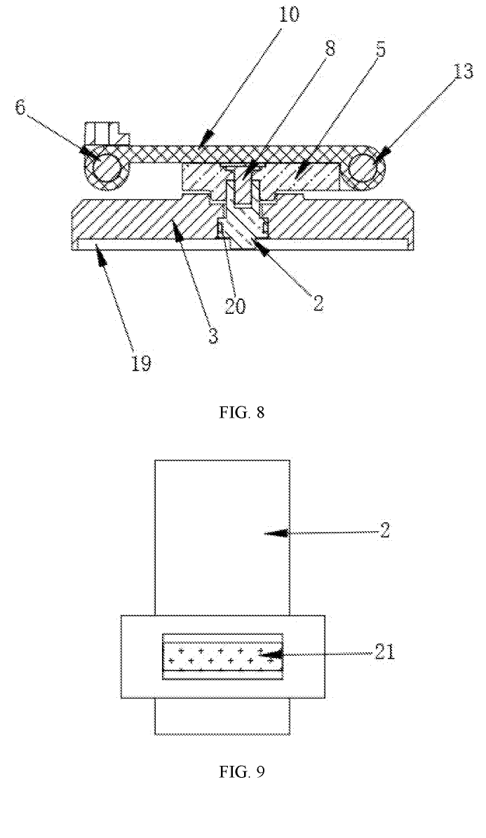

Referring to FIGS. 8 and 9, difference from Example 1 is as follows: a groove is provided at the first rotary shaft 2, and an arc-shaped elastic sheet 21 is welded in the groove. A middle of the arc-shaped elastic sheet 21 protrudes from the groove and elastically abuts against an inner wall of the lower component 3.

In specific use:

First use way: the mobile phone holder is adsorbed on a smooth surface such as glass and a table board through the suction cups 1. In this case, a mobile phone or a metal mobile phone housing is adsorbed through the magnet 16 on the upper component 15.

Second use way: the upper component 15 is adsorbed on a metal object such as an iron object and a steel object through the magnet 16, and the silica gel suction cups are adsorbed to a bare mobile phone.

Although the present disclosure has been described hereinbefore with reference to the embodiments, various modifications may be made thereto and equivalents may be substituted for components thereof without departing from the scope of the present disclosure. In particular, as long as there is no structural conflict, the features in the embodiments disclosed by the present disclosure can be combined with each other in any manner, and the failure to fully describe these combinations in this description is merely for the sake of space omission and resource conservation. Therefore, the present disclosure is not limited to the particular embodiments disclosed herein, but includes all technical solutions falling within the scope of the claims.

1. A vehicle-mounted and household magnetic, foldable and rotatable mobile phone holder capable of being adsorbed in two ways, comprising a lower component, wherein a rotary supporting frame is mounted on the lower component, and an upper component is mounted at the other end of the rotary supporting frame; and suction cups are mounted on the lower component, and a magnet is mounted on the upper component.

2. The vehicle-mounted and household magnetic, foldable and rotatable mobile phone holder capable of being adsorbed in two ways according to claim 1, wherein a bottom disc is arranged in a bottom cavity of the lower component, and the suction cups are fixedly mounted on the bottom disc.

3. The vehicle-mounted and household magnetic, foldable and rotatable mobile phone holder capable of being adsorbed in two ways according to claim 2, wherein one end of the upper component is provided with an annular groove, and the magnet is annular and embedded in the annular groove.

4. The vehicle-mounted and household magnetic, foldable and rotatable mobile phone holder capable of being adsorbed in two ways according to claim 3, wherein the rotary supporting frame comprises a lower connecting member, one end of the lower connecting member is hinged to a swing rod through a second rotary shaft, and one end of the swing rod is hinged to an upper connecting member through a third rotary shaft.

5. The vehicle-mounted and household magnetic, foldable and rotatable mobile phone holder capable of being adsorbed in two ways according to claim 4, wherein the lower component and the bottom disc are jointly arranged on a first rotary shaft in a sleeving manner, and the lower connecting member is connected to the first rotary shaft through a first screw.

6. The vehicle-mounted and household magnetic, foldable and rotatable mobile phone holder capable of being adsorbed in two ways according to claim 5, wherein the upper component and the upper connecting member are connected through a second screw.

7. The vehicle-mounted and household magnetic, foldable and rotatable mobile phone holder capable of being adsorbed in two ways according to claim 6, wherein a hardware decorative sheet is stuck to a nut of the first screw, a first decorative sheet and a second decorative sheet are stuck to two ends of the second rotary shaft respectively, a third decorative sheet and a fourth decorative sheet are stuck to two ends of the third rotary shaft respectively, and a surface sticker is stuck to the magnet.

8. The vehicle-mounted and household magnetic, foldable and rotatable mobile phone holder capable of being adsorbed in two ways according to claim 7, wherein a groove is provided at the first rotary shaft, and a magnetic block is stuck to an interior of the groove.

9. The vehicle-mounted and household magnetic, foldable and rotatable mobile phone holder capable of being adsorbed in two ways according to claim 7, wherein a groove is provided at the first rotary shaft, and an arc-shaped elastic sheet is welded in the groove.
